(19) United States
(12) Patent Application Publication
(10) Pub. No.: US 2025/0360691 A1
(43) Pub. Date: Nov. 27, 2025

(54) RELEASE FILM AND LAMINATE

(71) Applicant: ASAHI KASEI KABUSHIKI KAISHA, Tokyo (JP)

(72) Inventors: Akio YOSHIMURA, Tokyo (JP); Yi ZHANG, Tokyo (JP); Yan ZHANG, Tokyo (JP)

(73) Assignee: ASAHI KASEI KABUSHIKI KAISHA, Tokyo (JP)

(21) Appl. No.: 19/215,540

(22) Filed: May 22, 2025

(30) Foreign Application Priority Data
May 22, 2024 (CN) 202410637036.4
Jun. 17, 2024 (JP) 2024-097686

(51) Int. Cl. B32B 7/06; B32B 27/42

(52) U.S. Cl. CPC B32B 7/06; B32B 27/42; B32B 2307/748; B32B 2451/00

(57) ABSTRACT

According to the present disclosure, a release film having high rigidity and excellent releasability can be provided for protecting exterior films, particularly decorative films for automobiles. A release film includes a base layer containing a polyacetal resin.

### TECHNICAL FIELD

The present disclosure relates to a release film and a laminate.

### BACKGROUND

Films such as resin-based films are used for applications such as adhesion (e.g., exterior decoration, repair) or packaging, and in particular, are used as decorative films for automobiles. Such films are protected with a release film on one side (e.g., the adhesive side) or both sides for use in storage, distribution, adhesion, packaging, etc., and the release film is peeled off at the time of use of the film for adhesion, packaging, or the like.

In particular, as release films for decorative films for automobiles, multilayer structured films in which a base layer having rigidity but low releasability is combined with an easy peel film or release agent have been proposed (PTLs 1 to 3).

Such multilayer structured films have issues in that the number of production steps and production costs are increased, and if a film that has both rigidity and releasability achieved only with the base layer is used as a release film, it is expected that the number of production steps and production costs can be reduced.

### CITATION LIST

PTL 1: JP 6999405 B
PTL 2: JP 2023-80853 A
PTL 3: JP 2023-74354 A

### SUMMARY

According to the present disclosure, a release film having high rigidity and excellent releasability can be provided for protecting exterior films, particularly decorative films for automobiles.

The present inventors have conducted intensive studies in order to solve the above-mentioned issue, and as a result, have found that a film in which a polyacetal resin is used as the base layer has both excellent rigidity and releasability, and can be used as a release film without combining an easy peel film or release agent, thereby completing the present disclosure.

In other words, the present disclosure is as follows.

[1] A release film comprising a base layer containing a polyacetal resin.
[2] The release film according to [1], composed only of the base layer.
[3] The release film according to [1] or [2], wherein a flow rate of the polyacetal resin is 0.5 to 50 g/10 min.
[4] The release film according to any one of [1] to [3], wherein the base layer contains a heat stabilizer, and a median diameter (D50) of the heat stabilizer is 50 μm or less.
[5] The release film according to any one of [1] to [5], wherein the polyacetal resin is a copolymer, and the content of comonomers in the polyacetal resin is an amount equivalent to 2.0 mol % or less per 1 mol of trioxane.
[6] The release film according to any one of [1] to [5], being a release film for a decorative film for automobiles.
[7] The release film according to [6], wherein the decorative film for automobiles is a decorative film for automobiles of a type where an adhesive is applied immediately before adhesion.
[8] The release film according to any one of [1] to [7], being a release film for a film containing metal pigment particles.
[9] A laminate comprising a main film and the release film according to any one of [1] to [8] laminated on at least one side of the main film.
[10] The laminate according to [9], wherein, when an Ra of a surface of the release film after the main film is peeled off from the laminate, the surface of the release film being in contact with the main film before the peel-off of the main film, is 0.4 μm or less.
[11] A method for manufacturing the laminate according to [9] or [10], comprising laminating a component for forming the main film onto one side of the release film.
[12] A method for manufacturing a decorative film comprising:
(1) a step of obtaining a release film by extrusion molding a polyacetal resin;
(2) a step of coating a decorative layer or topcoat layer on a smooth surface of the release film obtained in (1) to obtain a laminate A;
(3) a step of coating an adhesive layer on the release film obtained in (1), and adhering the release film on the adhesive layer to obtain a laminate B; and
(4) a step of bonding the laminate A and the laminate B together after removing the release film from one side of the laminate B.
   [13] A single-layer release film (base layer) comprising a polyacetal resin, or use of a polyacetal resin as a single-layer release film (base layer).

The release film of the present disclosure had high rigidity, has excellent peelability, and can be suitably used as a release film to protect exterior films, particularly decorative films for automobiles.

### DETAILED DESCRIPTION

Hereinafter, the content of the present disclosure will be described.

### Release Film

The release film of the present disclosure comprises a base layer containing a polyacetal resin. The term “release film” refers to a film laminated to protect one side (e.g., adhesive side) or both sides of a main film (e.g., adhesive or packaging film, etc.) for use in storage, distribution, adhesion, packaging, etc., and which is peeled off from the main film at the time of use of the main film (e.g., upon adhesion or packaging).

### Polyacetal Resin

The polyacetal resin used in the present disclosure is not particularly limited, and well-known polyacetal resins may be used. Examples include, for example, a polyacetal homopolymer substantially consisting only of oxymethylene units, obtained by homopolymerizing a formaldehyde monomer or a cyclic oligomer of formaldehyde such as a trimer (trioxane) or tetramer (tetraoxane) thereof; and a polyacetal copolymer obtained by copolymerizing a formaldehyde monomer or a cyclic oligomer of formaldehyde such as a trimer (trioxane) or tetramer (tetraoxane) thereof with a cyclic ether, such as cyclic formal of glycols or diglycol, such as ethylene oxide, propylene oxide, epichlorohydrin, 1,3-dioxolane, or 1,4-butanediol formal.

Here, among polyacetal copolymers, from the viewpoint of better balance among rigidity, toughness, and heat resistance, preferred comonomers are 1,3-dioxolane and 1,4-butanediol formal. Furthermore, as polyacetal copolymers, a branched polyacetal copolymer having branches obtained by copolymerizing monofunctional glycidyl ether, or a crosslinked polyacetal copolymer having a crosslinked structure obtained by copolymerizing multifunctional glycidyl ether, may also be used. Furthermore, a block-type polyacetal homopolymer having block components obtained by polymerizing formaldehyde monomer or cyclic oligomers of formaldehyde in the presence of a compound having functional groups such as hydroxyl groups at both ends or at one end, such as polyalkylene glycol, or a block-type polyacetal copolymer having block components obtained by copolymerizing a formaldehyde monomer or a cyclic oligomer of formaldehyde such as a trimer (trioxane) or tetramer (tetraoxane) thereof, with a cyclic ether or cyclic formal in the presence of a compound having functional groups such as hydroxyl groups at both ends or at one end, such as hydrogenated polybutadiene glycol, may also be used.

The content of the comonomer in the polyacetal resin is preferably an amount equivalent to 2.0 mol % or less, more preferably an amount equivalent to 1.2 mol % or less, even more preferably an amount equivalent to 0.1 mol % or less, and particularly preferably an amount equivalent to 0 mol % (that is, the polyacetal resin is a polyacetal homopolymer) per 1 mol of trioxane. If the content of the comonomer is within the above-mentioned range, the crystallinity of the polyacetal resin per se is increased, and the rigidity of the resulting sheet is also increased.

In the present disclosure, a single type or a mixture of the above-mentioned polyacetal resin may be used, or two or more types may be used.

The method for producing the polyacetal resin is not particularly limited, and well-known methods for producing polyacetal resins may be used. For example, as A method for manufacturing a polyacetal resin in the case of a polyacetal homopolymer, a method is mentioned in which high-purity formaldehyde is introduced into an organic solvent containing a basic polymerization catalyst such as an organic amine, an organic or inorganic tin compound, or a metal hydroxide, polymerization is performed, the polymer is separated by filtration, and then heating is performed in acetic anhydride in the presence of sodium acetate to acetylate the polymer ends.

Furthermore, as A method for manufacturing a polyacetal resin of a polyacetal copolymer, a method is mentioned in which a mixed solution is used in which high-purity trioxane and comonomer components such as ethylene oxide, 1,3-dioxolane, or 1,4-butanediol formal, and a chain transfer agent for molecular weight control are uniformly mixed in an organic solvent such as cyclohexane, and the mixed solutions and a compound as a polymerization catalyst, such as a Lewis acid, e.g., boron trifluoride diethyl ether complex, are introduced into a twin-screw self-cleaning type reactor and cationically polymerized, and subsequently the polymerization catalyst is deactivated and the polymer terminal groups are stabilized.

Formic acid, methanol, and water present in trioxane, 1,3-dioxolane, and 1,4-butanediol significantly reduce the thermal stability of the resulting polymer and cause degradation of the polymer during sheet molding, making continuous production difficult. Therefore, it is necessary to remove them as completely as possible before the polymerization reaction, and the amount of impurities present in all the monomers is preferably 30 ppm or less, more preferably 20 ppm or less, and even more preferably 10 ppm or less.

As the polymerization reactor, a reactor capable of bulk polymerization is preferred, wherein trioxane, comonomer components, a chain transfer agent for molecular weight control, and a catalyst are introduced into a self-cleaning type extrusion kneader such as a cokneader, a twin-screw type continuous extrusion kneader, or a twin-paddle type continuous mixer, followed by the addition of a quaternary ammonium compound such as choline hydroxide formate to decompose and remove unstable terminal groups.

The melt flow rate of the polyacetal resin (unit: g/10 min) is an index of molecular weight and may be appropriately selected from the viewpoints of stability of the resin and productivity of films. The melt flow rate is preferably 0.5 or more, more preferably 0.8 or more, even more preferably 1.0 or more, and particularly preferably 1.6 or more. Furthermore, the melt flow rate is preferably 50 or less, more preferably 30 or less, even more preferably 15 or less, and particularly preferably 5 or less.

The content of the polyacetal resin in the release film of the present disclosure is preferably 90 mass % or more, more preferably 95 mass % or more, and even more preferably 99 mass % or more.

### Other Components

The release film (base layer) of the present disclosure may contain components other than the polyacetal resin (hereinafter referred to as “other components”). As the “other components” that may be contained in the release film of the present disclosure, for example, heat stabilizers, weather (light) stabilizers, and release agents can be used alone or in combination.

The release film (base layer) of the present disclosure preferably contains a heat stabilizer. Examples of the heat stabilizer include soluble heat stabilizers (e.g., low molecular weight compounds) and particulate heat stabilizers (e.g., polymers). In the case where the heat stabilizer is a particulate heat stabilizer, the melting point thereof is preferably 190° C. or lower, more preferably 175° C. or lower, and even more preferably 160° C. or lower. The median diameter (D50) of the heat stabilizer is preferably 50 μm or less, more preferably 25 μμm or less, even more preferably 10 μm or less, and particularly preferably 5 μm or less. Examples of such heat stabilizers include antioxidants and scavengers for formaldehyde or formic acid.

Using antioxidants, scavengers for formaldehyde or formic acid, or a combination thereof as the heat stabilizer are effective. As the antioxidant, hindered phenol-based antioxidants are preferred, and examples include n-octadecyl-3-(3′,5′-di-t-butyl-4′-hydroxyphenyl)propionate, n-octadecyl-3-(3′-methyl-5′-t-butyl-4′-hydroxyphenyl)propionate, n-tetradecyl-3-(3′,5′-di-t-butyl-4′-hydroxyphenyl)propionate, 1,6-hexanediol bis(3-(3′,5′-di-t-butyl-4′-hydroxyphenyl)propionate), 1,4-butanediol bis(3-(3′,5′-di-t-butyl-4′-hydroxyphenyl)propionate), triethylene glycol bis(3-(3′-t-butyl-5′-methyl-4′-hydroxyphenyl)propionate), tetrakis(methylene-3-(3′,5′-di-t-butyl-4′-hydroxyphenyl)propionate)methane, 3,9-bis(2-(3-(3′-t-butyl-4′-hydroxy-5′-methylphenyl)propionyloxy)-1,1-dimethylethyl)-2,4,8,10-tetraoxaspiro(5,5)undecane, N,N′-bis(3-(3′,5′-di-t-butyl-4′-hydroxyphenyl)propionyl)hexamethylenediamine, N,N′-tetramethylene bis(3-(3′-methyl-5′-t-butyl-4′-hydroxyphenyl)propionyl)diamine, N,N′-bis(3-(3′,5′-di-t-butyl-4′-hydroxyphenyl)propionyl)hydrazine, N-salicylidene-N′-salicylhydrazone, 3-(N-salicyloyl)amino-1,2,4-triazole, and N,N′-bis(2-(3-(3′,5′-di-t-butyl-4′-hydroxyphenyl)propionyloxy)ethyl)oxyamide.

Among these hindered phenol-based antioxidants, triethylene glycol bis-(3-(3′-t-butyl-5′-methyl-4′-hydroxyphenyl)propionate) and tetrakis-(methylene-3-(3′,5′-di-t-butyl-4′-hydroxyphenyl)propionate)methane are preferred.

Examples of the scavengers for formaldehyde and formic acid include: (i) compounds and polymers containing formaldehyde-reactive nitrogen, and (ii) hydroxides, inorganic acid salts, carboxylates, and alkoxides of alkali metals or alkaline earth metals.

Examples of the (i) compounds containing formaldehyde-reactive nitrogen include (1) dicyandiamide, (2) amino-substituted triazine, and (3) co-condensates of amino-substituted triazine and formaldehyde. Examples of the (2) amino-substituted triazines include, for example, guanamine (2,4-diamino-sym-triazine), melamine (2,4,6-triamino-sym-triazine), N-butylmelamine, N-phenylmelamine, N,N-diphenylmelamine, N,N-diallylmelamine, N,N′,N″-triphenylmelamine, N-methylolmelamine, N,N′-dimethylolmelamine, N,N′,N″-trimethylolmelamine, benzoguanamine (2,4-diamino-6-phenyl-sym-triazine), 2,4-diamino-6-methyl-sym-triazine, 2,4-diamino-6-butyl-sym-triazine, 2,4-diamino-6-benzyloxy-sym-triazine, 2,4-diamino-6-butoxy-sym-triazine, 2,4-diamino-6-cyclohexyl-sym-triazine, 2,4-diamino-6-chloro-sym-triazine, 2,4-diamino-6-mercapto-sym-triazine, 2,4-dioxy-6-amino-sym-triazine (Ammelide), 2-oxy-4,6-diamino-sym-triazine (Ameline), and N,N,N′, N′-tetracyanoethylbenzoguanamine. Examples of the (3) co-condensates of amino-substituted triazines and formaldehyde include, for example, melamine-formaldehyde polycondensates. Among these, dicyandiamide, melamine, and melamine-formaldehyde polycondensates are preferred.

Furthermore, examples of the (i) polymers having a formaldehyde-reactive nitrogen group may also include (1) polyamide resins, (2) polymers obtained by polymerizing acrylamide and derivatives thereof or acrylamide and derivatives thereof with other vinyl monomers in the presence of a metal alcoholate, (3) polymers obtained by polymerizing acrylamide and derivatives thereof or acrylamide and derivatives thereof with other vinyl monomers in the presence of a radical polymerization initiator, and (4) polymers containing nitrogen groups such as amines, amides, ureas, and urethanes. Examples of the (1) polyamide resins include nylon 4-6, nylon 6, nylon 6-6, nylon 6-10, nylon 6-12, nylon 12, and copolymers thereof, such as nylon 6/6-6, nylon 6/6-6/6-10, and nylon 6/6-12, for example. Examples of the (2) polymers obtained by polymerizing acrylamide and derivatives thereof or acrylamide and derivatives thereof with other vinyl monomers in the presence of a metal alcoholate include poly-β-alanine copolymers. These polymers can be produced by the methods disclosed in JP H6-12259 B, JP H5-87096 B, JP H5-47568 B, and JP H3-234729 A. The (3) polymers obtained by polymerizing acrylamide and derivatives thereof or acrylamide and derivatives thereof with other vinyl monomers in the presence of a radical polymerization initiator can be produced by the method disclosed in JP H3-28260 A.

Examples of the (b) hydroxides, inorganic acid salts, carboxylates, and alkoxides of alkali metals or alkaline earth metals include hydroxides of sodium, potassium, magnesium, calcium, or barium, and carbonates, phosphates, silicates, borates, and carboxylates of these metals. The carboxylic acids in these carboxylates are saturated or unsaturated aliphatic carboxylic acids having 10 to 36 carbon atoms, and these carboxylic acids may be substituted with hydroxyl groups. Examples of saturated aliphatic carboxylic acids include capric acid, lauric acid, myristic acid, palmitic acid, stearic acid, arachidic acid, behenic acid, lignoceric acid, cerotic acid, montanic acid, melissic acid, and ceroplastic acid. Examples of unsaturated aliphatic carboxylic acids include undecylenic acid, oleic acid, elaidic acid, cetoleic acid, erucic acid, brassidic acid, sorbic acid, linoleic acid, linolenic acid, arachidonic acid, propiolic acid, and stearolic acid. Furthermore, examples of alkoxides include methoxides and ethoxides of the above-mentioned metals.

As weather (light) stabilizers, (i) benzotriazole-based substances, (ii) oxalic acid anilide-based substances, and (iii) hindered amine-based substances are preferred. Examples of the (i) benzotriazole-based substances include 2-(2′-hydroxy-5′-methylphenyl)benzotriazole, 2-[2′-hydroxy-3,5-di-t-butylphenyl]benzotriazole, 2-[2′-hydroxy-3,5-diisoamylphenyl]benzotriazole, 2-[2′-hydroxy-3,5-bis(α,α-dimethylbenzyl)phenyl]-2H-benzotriazole, and 2-(2′-hydroxy-4′-octoxyphenyl)benzotriazole, for example, and 2-[2′-hydroxy-3,5-bis(α,α-dimethylbenzyl)phenyl]-2H-benzotriazole and 2-[2′-hydroxy-3,5-di-t-butylphenyl]benzotriazole are preferred.

Examples of the (b) oxalic acid anilide-based substances include 2-ethoxy-2′-ethyloxalic acid bis-anilide, 2-ethoxy-5-t-butyl-2′-ethyloxalic acid bis-anilide, and 2-ethoxy-3′-dodecyloxalic acid bis-anilide, for example. Each of these substances may be used alone, or two or more may be used in combination.

Examples of the (c) hindered amine-based substances include 4-acetoxy-2,2,6,6-tetramethylpiperidine, 4-stearoyloxy-2,2,6,6-tetramethylpiperidine, 4-acryloyloxy-2,2,6,6-tetramethylpiperidine, 4-(phenylacetoxy)-2,2,6,6-tetramethylpiperidine, 4-benzoyloxy-2,2,6,6-tetramethylpiperidine, 4-methoxy-2,2,6,6-tetramethylpiperidine, 4-stearoyloxy-2,2,6,6-tetramethylpiperidine, 4-cyclohexyloxy-2,2,6,6-tetramethylpiperidine, 4-benzyloxy-2,2,6,6-tetramethylpiperidine, 4-phenoxy-2,2,6,6-tetramethylpiperidine, 4-(ethylcarbamoyloxy)-2,2,6,6-tetramethylpiperidine, 4-(cyclohexylcarbamoyloxy)-2,2,6,6-tetramethylpiperidine, 4-(phenylcarbamoyloxy)-2,2,6,6-tetramethylpiperidine, bis(2,2,6,6-tetramethyl-4-piperidyl) carbonate, bis (2,2,6,6-tetramethyl-4-piperidyl) oxalate, bis(2,2,6,6-tetramethyl-4-piperidyl) malonate, bis(2,2,6,6-tetramethyl-4-piperidyl) sebacate, bis(2,2,6,6-tetramethyl-4-piperidyl) adipate, bis(2,2,6,6-tetramethyl-4-piperidyl) terephthalate, 1,2-bis(2,2,6,6-tetramethyl-4-piperidyloxy)ethane, α,α′-bis(2,2,6,6-tetramethyl-4-piperidyloxy)-p-xylene, bis(2,2,6,6-tetramethyl-4-piperidyl) tolylene-2,4-dicarbamate, bis(2,2,6,6-tetramethyl-4-piperidyl) hexamethylene-1,6-dicarbamate, tris(2,2,6,6-tetramethyl-4-piperidyl) benzene-1,3,5-tricarboxylate, and tris(2,2,6,6-tetramethyl-4-piperidyl) benzene-1,3,4-tricarboxylate; and bis(2,2,6,6-tetramethyl-4-piperidyl) sebacate is preferably used. Each of the above-mentioned hindered amine-based substances may be used alone, or two or more may be used in combination. Furthermore, a combination of the above-mentioned benzotriazole-based substances or oxalic acid anilide-based substances, and hindered amine-based substances is most preferable.

Examples of the release agent include, for example, fatty acids, esters of alcohols and fatty acids, esters of alcohols and dicarboxylic acids, fatty acid amides, metal soaps, polyoxyalkylene glycols, olefin compounds having an average polymerization degree of 10 to 500, and silicone oils. Examples of the alcohol include, for example, monohydric alcohols and polyhydric alcohols, and examples of monohydric alcohols include octyl alcohol, capryl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, oleyl alcohol, nonadecyl alcohol, eicosyl alcohol, behenyl alcohol, ceryl alcohol, melissyl alcohol, 2-hexyldecanol, 2-octyldodecanol, 2-decyl-tetradecanol, and unilin alcohol. The polyhydric alcohols are polyhydric alcohols containing 2 to 6 carbon atoms, and examples include ethylene glycol, diethylene glycol, triethylene glycol, propylene glycol, dipropylene glycol, butanediol, pentanediol, hexanediol, glycerin, diglycerin, triglycerin, threitol, erythritol, pentaerythritol, arabitol, ribitol, xylitol, sorbit, sorbitan, sorbitol, and mannitol. Examples of the fatty acids include capric acid, lauric acid, myristic acid, palmitic acid, stearic acid, 12-hydroxystearic acid, arachidic acid, behenic acid, lignoceric acid, cerotic acid, montanic acid, melissic acid, ceroplastic acid, undecylenic acid, oleic acid, elaidic acid, cetoleic acid, erucic acid, brassidic acid, sorbic acid, linoleic acid, linolenic acid, arachidonic acid, propiolic acid, stearolic acid, and naturally occurring fatty acids containing such components or mixtures thereof. These fatty acids may also be substituted with hydroxyl groups.

As esters of alcohols and fatty acids, among the fatty acid compounds, fatty acid esters derived from fatty acids selected from palmitic acid, stearic acid, behenic acid, and montanic acid, and polyhydric alcohols selected from glycerin, pentaerythritol, sorbitan, and sorbitol are preferred. These fatty acid ester compounds may or may not have hydroxyl groups. There is no particular limitation. For example, they may be monoesters, diesters, or triesters. Furthermore, hydroxyl groups may be blocked with boric acid or the like. Examples of preferable fatty acid esters include glycerin monopalmitate, glycerin dipalmitate, glycerin tripalmitate, glycerin monostearate, glycerin distearate, glycerin tristearate, glycerin monobehenate, glycerin dibehenate, glycerin tribehenate, glycerin monomontanate, glycerin dimontanate, glycerin trimontanate, pentaerythritol monopalmitate, pentaerythritol dipalmitate, pentaerythritol tripalmitate, pentaerythritol tetrapalmitate, pentaerythritol monostearate, pentaerythritol distearate, pentaerythritol tristearate, pentaerythritol tetrastearate, pentaerythritol monobehenate, pentaerythritol dibehenate, pentaerythritol tribehenate, pentaerythritol tetrabehenate, pentaerythritol monomontanate, pentaerythritol dimontanate, pentaerythritol trimontanate, pentaerythritol tetramontanate, sorbitan monopalmitate, sorbitan dipalmitate, sorbitan tripalmitate, sorbitan monostearate, sorbitan distearate, sorbitan tristearate, sorbitan monobehenate, sorbitan dibehenate, sorbitan tribehenate, sorbitan monomontanate, sorbitan dimontanate, sorbitan trimontanate, sorbitol sorbitol monopalmitate, dipalmitate, sorbitol tripalmitate, sorbitol monostearate, sorbitol distearate, sorbitol tristearate, sorbitol monobehenate, sorbitol dibehenate, sorbitol tribehenate, sorbitol monomontanate, sorbitol dimontanate, and sorbitol trimontanate. Furthermore, as aliphatic ester compounds in which the hydroxyl groups are blocked by boric acid or the like, boric acid esters of glycerin mono fatty acid esters can be mentioned.

The esters of alcohols and dicarboxylic acids are monoesters or diesters of saturated or unsaturated alcohols such as methyl alcohol, ethyl alcohol, propyl alcohol, n-butyl alcohol, isobutyl alcohol, t-butyl alcohol, n-amyl alcohol, 2-pentanol, n-heptyl alcohol, n-octyl alcohol, n-nonyl alcohol, lauryl alcohol, myristyl alcohol, cetyl alcohol, stearyl alcohol, and behenyl alcohol, and dicarboxylic acids such as oxalic acid, malonic acid, succinic acid, glutaric acid, adipic acid, pimelic acid, suberic acid, azelaic acid, sebacic acid, undecanedioic acid, brassylic acid, maleic acid, fumaric acid, and glutaconic acid. As fatty acid amides, aliphatic amide compounds composed of aliphatic carboxylic acids having 16 or more carbon atoms and aliphatic amines or aliphatic diamines are used.

Examples of carboxylic acids constituting such aliphatic amides include palmitic acid, isopalmitic acid, stearic acid, isostearic acid, behenic acid, lignoceric acid, cerotic acid, heptacosanoic acid, montanic acid, melissic acid, lacceryl acid, cetrearylic acid, and erucic acid. Examples of the amines and diamines include ammonia and ethylenediamine. Examples of such amide compounds include stearylamide, palmitylamide, oleylamide, methylenebisstearamide, ethylenebisstearamide, and ethylenebisoleylamide. Examples of the metal soaps include zinc stearate, calcium stearate, and magnesium stearate. Examples of the polyoxyalkylene glycols include, for example, condensation polymers including an alkylene glycol as a monomer as a first group. Examples include polyethylene glycol, polypropylene glycol, and polyethylene glycol-polypropylene glycol block polymer, for example. A preferred range of the number of polymerization units in these is from 5 to 1000, and a more preferred range is from 10 to 500.

The second group is ether compounds of the first group and aliphatic alcohols. Examples include polyethylene glycol oleyl ether (amount of polymerized ethylene oxide in moles: 5 to 50), polyethylene glycol cetyl ether (amount of polymerized ethylene oxide in moles: 5 to 20), polyethylene glycol stearyl ether (amount of polymerized ethylene oxide in moles: 5 to 30), polyethylene glycol lauryl ether (amount of polymerized ethylene oxide in moles: 5 to 30), polyethylene glycol tridecyl ether (amount of polymerized ethylene oxide in moles: 5 to 30), polyethylene glycol nonylphenyl ether (amount of polymerized ethylene oxide in moles: 2 to 100), and polyethylene glycol octylphenyl ether (amount of polymerized ethylene oxide in moles: 4 to 50). The third group is ester compounds of the first group and higher fatty acids. Examples include polyethylene glycol monolaurate (amount of polymerized ethylene oxide in moles: 2 to 30), polyethylene glycol monostearate (amount of polymerized ethylene oxide in moles: 2 to 50), and polyethylene glycol monooleate (amount of polymerized ethylene oxide in moles: 2 to 10), for example.

Olefin compounds having an average polymerization degree of 10 to 500 are compounds represented by the following general formula:

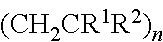

in the formula, R¹ and R² are each independently selected from hydrogen, alkyl group, aryl group, and ether group, and n represents the average polymerization degree and is from 10 to 500.

Examples of alkyl groups include, for example, ethyl groups, propyl groups, butyl groups, hexyl groups, octyl groups, decyl groups, lauryl groups, cetyl groups, and stearyl groups, while examples of aryl groups include, for example, phenyl groups, p-butylphenyl groups, p-octylphenyl groups, p-nonylphenyl groups, benzyl groups, p-butylbenzyl groups, trityl groups, and xylil groups. Furthermore, examples of ether groups include, for example, ethyl ether groups, propyl ether groups, butyl ether groups, and others. Specific examples of monomers constituting olefin compounds include ethylene, propylene, 1-butene, 2-butene, isobutylene, 1-pentene, 2-pentene, 2-methyl-1-butene, 3-methyl-1-butene, 2-methyl-2-butene, 1-hexene, 2,3-dimethyl-2-butene, 1-heptene, 1-octene, 1-nonene, and 1-decene, and others represented by olefin-based monomers, or diene-based monomers represented by allene, 1,2-butadiene, 1,3-butadiene, 1,3-pentadiene, 1,4-pentadiene, 1,5-hexadiene, cyclopentadiene, and others. The compound may be ones obtained by copolymerizing two or more of these olefin-based monomers and diene-based monomers. In cases where the olefin compound is a compound obtained by polymerizing diene-based monomers, it is preferable to use an olefin compound that has been hydrogenated using conventional hydrogenation methods, which reduces the carbon-carbon unsaturated bonds as much as possible for improved heat stability.

The content of the above-mentioned components in the release film (base layer) of the present disclosure is preferably 5 mass % or less, more preferably 1 mass % or less, and even more preferably 0 mass %.

On the other hand, it is preferable that the release film (base layer) of the present disclosure is free of, or contains only minimal amounts of, the following components.

It is preferable that the release film (base layer) of the present disclosure is free of, or contains only minimal amounts of, components other than polyacetal resins used as an easy peel film or release agent. Examples of such components include, for example, silicon-containing compounds, PTFE-containing compounds, and others.

### Base Layer

The “base layer” refers to the layer that serves as the base of the release film. The release film of the present disclosure is preferably a single-layer release film composed only of a base layer containing a polyacetal resin. Since the polyacetal resin per se has releasability, the release film of the present disclosure may be configured not to include other components that provide releasability, such as an easy peel film and release agent. Since the release film of the present disclosure is composed only of a base layer, production steps and production costs can be reduced.

### Thickness, Manufacturing Method, Etc. of Release Film

The thickness of the release film of the present disclosure is not particularly limited, but it is preferably 30 μm or more, more preferably 50 μm or more, preferably 200 μm or less, and more preferably 100 μm or less. The method for manufacturing the release film of the present disclosure is not particularly limited, but the release film may be manufactured, for example, by methods such as biaxial extrusion molding, uniaxial extrusion molding, or biaxial or uniaxial stretching. Additionally, the release film of the present disclosure may be stretched or may not be stretched. Furthermore, the release film may be molded into a shape corresponding to the desired shape of the main film, so that the release film has a function to maintain the shape of the main film.

The molding method for polyacetal resin films involves melt kneading a polyacetal resin composition in a single-screw or twin-screw extruder to produce pellets of the polyacetal resin composition, as mentioned above. Subsequently, the pellets are melted in a single-screw or twin-screw extruder, and then one of the following molding methods may be used: (1) a cast method of continuously forming a sheet by supplying the molten polyacetal resin composition between a forming roller and a forming drum made of a metal or rubber, by means of the narrow nip pressure between the forming roller and the forming drum; or (2) a sleeve-touch method of continuously forming a sheet by supplying the molten polyacetal resin composition between a rotating forming roller and a cylindrical forming drum (sleeve) made of a thin-walled pipe that is flexible in the radial direction and rotates while making arcuate contact with a part of the outer peripheral surface of the forming roller, and by compressing the resin between the forming roller and the forming drum. Among these, the molding method (1) is preferred for achieving the effects of the present disclosure.

As for molding conditions, it is preferable that the temperature of the forming roller is in the range from 60° C. to the crystallization onset temperature of the polyacetal resin composition. When the temperature is in this range, a polyacetal resin sheet with excellent mold releasability between the forming roller and the polyacetal resin composition and excellent uniformity in thickness can be obtained. The temperature is more preferably in the range from 80° C. to the crystallization onset temperature, and even more preferably in the range from 100° C. to the crystallization onset temperature of the polyacetal resin composition.

### Laminate

The laminate of the present disclosure includes a main film and a release film laminated on at least one surface of the main film. The “main film” is not particularly limited as long as it is used as a film, but typically refers to a film for adhesion or packaging purposes, such as decorative films, for example. The “laminate” is a laminated film with a release film laminated on one side (e.g., the adhesive side) or both sides of the main film, used for storage, distribution, adhesion, or the like of the main film.

The “main film” is not particularly limited, but examples include films used for applications, such as adhesion (e.g., exterior decoration or repair) or packaging, in particular, decorative films (e.g., decorative films for automobiles), for example. The main film may also be a type of film where an adhesive is applied immediately before adhesion (e.g., decorative films for automobiles). The material for the main film is not particularly limited, but it may be a resin-based film, for example. Additionally, the main film may contain a coloring agent (e.g., metal pigment particles) for appearance decoration. The shape of the metal pigment particles is not particularly limited, but examples include scale shapes, flat shapes, and plate shapes. From the perspective of achieving a good metallic luster, scale shapes are preferred, for example. The material of the metal pigment particles is not particularly limited, but examples include metals such as aluminum, chromium, nickel, tin, titanium, indium, copper, gold, silver, and brass, as well as alloys or compounds containing such metals. From the perspective of metallic luster, it is preferable that the metal pigment particles contain aluminum.

If the surface of the release film after the main film is peeled off from the laminate, the surface of the release film being in contact with the main film before the peel-off of the main film, is smooth, the surface of the transferred base film will be smooth, resulting in a main film with excellent appearance. Ra of the surface of the release film after the main film is peeled off from the laminate, the surface of the release film being in contact with the main film before the peel-off of the main film, is preferably 0.4 μm or less, more preferably 0.25 μm or less, and even more preferably 0.1 μm or less.

### EXAMPLES

The following provides a more detailed description of the present disclosure through specific examples and comparative examples. However, the present disclosure is not limited to the following examples. Measurement and evaluation methods employed in the examples and comparative examples will be described.

### Polyacetal Resin Composition

### POM Composition 1 (Homopolymer)

A POM Composition 1 was prepared as follows.

A 5 L tank polymerization reactor with a jacket and equipped with a stirrer was filled with 2 L of n-hexane, and a circulation line (with an inner diameter of 6 mm and a length of 2.5 m) was attached. The n-hexane was circulated at 20 L/hr using a pump. Dehydrated formaldehyde gas was directly supplied to the circulation line at a rate of 200 g/hr. Additionally, a catalyst (dimethyldistearylammonium acetate) was supplied to the circulation line immediately before the reactor. A chain transfer agent (acetic acid anhydride) was added to the hexane, which was supplied to compensate for the decrease in the polymer slurry fed to the next stage, by adjusting the amount in the range of 0.13 to 0.52 g/hr. The polymerization was carried out at 58° C. under continuous feeding, resulting in a polymer slurry containing crude polymer. The amounts of the polymerization catalyst and chain transfer agent were adjusted so that the melt flow rate (MFR) of the polyacetal resin composition had the values in Table 1.

The obtained polymer slurry was reacted at 140° C. for 2 hours in a mixture of hexane and acetic acid anhydride in a ratio of 1:1 to stabilize the polymer by acetylating the molecular ends. The polymer after the reaction was collected by filtration, decompressed to 2 mmHg or lower, and dried for 3 hours in a vacuum dryer and set at 80° C. to yield polyacetal homopolymer powder.

Thereafter, 100 parts by mass of this powder was mixed with 0.2 parts by mass of Irganox 245 (manufactured by Ciba Specialty Chemicals) as a stabilizer and 0.2 parts by mass of H-3 (manufactured by Asahi Kasei Finechem Co., Ltd.) in a Henschel mixer for 1 minute. H-3 was pulverized in advance to a median diameter (D50) of 4 μm before mixing. The resulting mixture was then fed into a twin-screw extruder (BT-30 manufactured by Plastic Industry Co., Ltd., with an L/D of 44) set at 200°° C., and melt kneaded at a screw rotation speed of 100 rpm at 24 amperes to obtain polyacetal homopolymer pellets. The operation was conducted with minimal oxygen intrusion from the feeding of the raw materials to the collection of the pellets.

### POM Composition 2 (Homopolymer)

A POM Composition 2 was obtained in a similar manner to the POM Composition 1 in Example 1, except that the amount of the chain transfer agent was adjusted so that the MFR was 50 g/10 min.

### POM Composition 3 (Homopolymer)

A POM Composition 3 was obtained in a similar manner to the POM Composition 1 in Example 1, except that the amount of the chain transfer agent was adjusted so that the MFR was 100 g/10 min.

### POM Composition 4 (Homopolymer)

A POM Composition 4 was obtained in a similar manner to the POM Composition 1 in Example 1, except that H-3 was pulverized to a median diameter (D50) of 30 μm.

### POM Composition 5 (Homopolymer)

A POM Composition 5 was obtained in a similar manner to the POM Composition 1 in Example 1, except that H-3 was pulverized to a median diameter (D50) of 100 μm.

### POM Composition 6 (Homopolymer)

A POM Composition 6 was obtained in a similar manner to the POM Composition 1 in Example 1, except that a thermal stabilizer was used in the form of a ternary copolymer of polyamide 6/66/610 (manufactured by Asahi Kasei, product: NA900), the copolymer was pulverized to a median diameter (D50) of 40 μm.

### POM Composition 7 (Copolymers)

A POM Composition 7 was prepared as follows.

First, the polymerization step was carried out as described below.

A self-cleaning type twin-screw paddle continuous mixing reactor (with a screw diameter of 3 inches and a length-to-diameter ratio (L/D) of 10) equipped with a jacket capable of circulating a heat medium was adjusted to 80° C. Ingredients were continuously fed into the continuous mixing reactor. Specifically, trioxane as the main monomer was fed at 3750 g/hr, 1,3-dioxolane as the comonomer was fed in the range of 25 to 150 g/hr, methylal as the chain transfer agent was fed in the range of 2.0 to 8.0 g/hr (all the ingredients were subjected to impurity reduction treatment).

Furthermore, polymerization was carried out by adding a 1 mass % cyclohexane solution of boron trifluoride di-n-butyl etherate to the continuous mixing reactor as the polymerization catalyst such that the amount of the catalyst was 2.0×10⁻⁵ mol per 1 mol of trioxane, to thereby obtain polymer flakes. The amounts of the polymerization catalyst and chain transfer agent were adjusted so that the melt flow rate (MFR) of the polyacetal resin composition (P) had the values in Table 1.

The obtained polymer flakes were pulverized, and the pulverized polymer flakes were placed in a 1% aqueous solution of triethylamine and stirred to deactivate the polymerization catalyst. Subsequently, the polymer flakes in the 1% aqueous triethylamine solution were filtered, washed, and dried, in this sequence, yielding crude polymer.

To 1 part by mass of the obtained crude polymer, triethyl(2-hydroxyethyl)ammonium formate was added as a quaternary ammonium compound in an amount equivalent to 20 ppm when converted to the amount of nitrogen using the following equation (i), and after uniform mixing, the mixture was dried at 120° C. for 3 hours to obtain a dried polymer:

$$Amount of quaternary ammonium compound added = P \times 14 / Q \qquad ( i )$$

in formula (i), P represents the concentration (ppm by mass) of the quaternary ammonium compound relative to the crude polymer, 14 is the atomic weight of nitrogen, and Q is the molecular weight of the quaternary ammonium compound.

Subsequently, terminal stabilization and pelletizing steps were carried out on the obtained dried polymer.

The obtained dried polymer was added to the front section of a twin-screw extruder with a vent (BT-30 manufactured by Plastic Industry Co., Ltd., with an L/D of 44, a setting temperature of 200° C., and a rotation speed of 80 rpm). Furthermore, 0.5 parts by mass of water per 100 parts by mass of the dried polymer was added. The polymer was subjected to terminal stabilization under the condition of an average residence time of 1 minute while vacuum degassing.

Subsequently, 0.2 parts by mass of Irganox 245 (manufactured by Ciba Specialty Chemicals) as a stabilizer and 0.2 parts by mass of H-3 (manufactured by Asahi Kasei Finechem Co., Ltd.) per 100 parts by mass of the dried polymer were mixed in advance for 1 minute in a Henschel mixer. The resulting mixture was fed from the side feeder located in the rear section of the twin-screw extruder (BT-30 manufactured by Plastic Industry Co., Ltd. with an L/D of 44) set to 200° C., and was melt kneaded at a screw rotation speed of 100 rpm and 24 amperes to obtain pellets of polyacetal copolymer (A-2). The operation was conducted with minimal oxygen intrusion from the feeding of the raw materials to the collection of the pellets.

### PET Resin

PET resin pellets (grade name: TRN-RTJ) manufactured by Teijin Ltd. were used as a PET resin.

### Extrusion Molding of Release Film

Pellets of the POM compositions prepared as described above were melted using a single-screw extruder set at a cylinder temperature of 230° C., and a film (with a thickness of 50 μm) was continuously formed by feeding the molten resin between a rotating metal forming roller (at a temperature of 140° C.) and a rotating rubber roller, by means of the narrow nip pressure between these forming rollers.

### Preparation of Adhesive

Adhesive 2 was prepared by uniformly mixing 16 parts by mass of Daiferamin™ MAU-#5000 and 84 parts by mass of MEK.

### Preparation of Coating Compositions

### Clear Coating Composition

A clear coating composition was obtained by uniformly mixing 60 parts by mass of Kansai Paint™ PG80 #026, 6 parts by mass of Kansai Paint™ RETAN PG80 hardener, and 34 parts by mass of Kansai Paint™ RETAN PG thinner.

### Black Coating Composition

A black coating composition was obtained by uniformly mixing 60 parts by mass of Kansai Paint™ PG80 #400, 6 parts by mass of Kansai Paint™ RETAN PG80 hardener, and 34 parts by mass of Kansai Paint™ RETAN PG thinner.

### Metallic Coating Composition

A metallic coating composition was prepared by uniformly mixing 20 parts by mass of Toyal Shine™ TS-408PM, i.e., metal pigment particles, and 80 parts by mass of MEK.

### Example 1

The POM composition 1 listed in Table 1 was obtained according to the above-described method for producing the POM composition, and then a release film 1 was obtained according to the above-described method for extrusion molding of the release film.

The clear coating composition was applied on the substantially smooth surface of the release film 1 with a Meyer bar coater using a No. 8 Meyer bar, followed by drying in an oven at about 100° C. for about 1 minute to produce a laminate A with a thickness of about 0.4 micrometers.

Subsequently, the adhesive 1 was coated on a FILMBYNA™ 38E-0020 manufactured by Fujimori Kogyo Co., Ltd, as another peel-off liner, and the adhesive layer was dried in an oven at about 80° C. for about 3 minutes and then at about 120° C. for about 5 minutes to form an adhesive layer with a thickness of about 40 micrometers. The release film 1 was then laminated onto the adhesive layer using a heat lamination method to produce an adhesive transfer film B.

After the peel-off liner of adhesive transfer film B was removed, the adhesive transfer film B was laminated onto the clear coating layer of the laminate A via the adhesive layer by heat lamination, yielding a laminate.

### Example 2

A laminate was obtained by performing the same procedures as in Example 1, except that the POM composition 2 was used.

### Comparative Example 1

A laminate was obtained by performing the same procedures as in Example 1, except that the POM composition 3 was used.

### Example 3

A laminate was obtained by performing the same procedures as in Example 1, except that the POM composition 4 was used.

### Comparative Example 2

A laminate was obtained by performing the same procedures as in Example 1, except that the POM composition 5 was used.

### Example 4

A laminate was obtained by performing the same procedures as in Example 1, except that the POM composition 6 was used.

### Example 5

A laminate was obtained by performing the same procedures as in Example 1, except that the POM composition 7 was used.

### Example 6

A laminate was obtained by performing the same procedures as in Example 1, except that the black coating composition was used instead of the clear coating composition.

### Example 7

A laminate was obtained by performing the same procedures as in Example 1, except that the metallic coating composition was used instead of the clear coating composition.

### Comparative Example 3

A laminate was obtained by performing the same procedures as in Example 1, except that the PET resin was used and the cylinder temperature of the extruder was set to 280° C.

### Comparative Example 4

The POM composition 1 was used as the resin forming the outer peel-off layer, a hydrogenated random copolymer of 20% by weight of styrene and 80% by weight of butadiene (DYNARON R “4600P” (trade name) manufactured by JSR Corporation) was used as the resin forming the intermediate adhesive layer, and PP (“FG3DG” (trade name) manufactured by Nippon Polychem Co., Ltd.,) was used as the resin forming the inner substrate layer. A tubular melt film was extruded using the three-layer co-extrusion inflation method so that the thicknesses of the outer layer, intermediate layer, and inner layer were 50 micrometers, 10 micrometers, and 60 micrometers, respectively. After introducing air into the resulting tubular melt film to inflate it, water was introduced from the sizing ring surrounding the tubular melt film to cool and solidify the film. The film was folded by pinch rolls, pulled, and the sides were cut open, after which the resulting film was wound to obtain the laminate.

### Evaluation Methods

### Productivity of Film

The films that could not be produced successfully due to drawing were rated as “Poor,” the films that could be produced with a little drawing were rated as “Fair,” and the films that could be produced with no drawing were rated as “Excellent.”

### Appearance of Film

Films were visually observed, and the film was rated as “Poor” if the number of visible air marks was within a 30 cm square was more than 10; the film was rated as “Fair” if the number was more than 5 and 10 or less; the film was rated as “Excellent” if the number was 5 or less. Air marks with a size of about 200 micrometers or less were counted.

### Stiffness of Film

In actual use, a certain degree of stiffness is required during the application process. If the stiffness of the film was insufficient, the film was rated as “Poor”; if the film was actually usable but was difficult for application, the film was rated as “Fair”; if the film was actually usable and had sufficient stiffness for application, the film was rated as “Excellent.”

### Peelability

If the peelability was good for actual use (the film was easily peeled off and no residue was left), the film was rated as “Excellent”; if the film was difficult to be peeled off (adhesion was strong, peel-off marks remained, etc.), it was rated as “Poor.”

### Smoothness of Film Surface

The surface roughness Ra of the release film on the side from which the main film was peeled off was measured. If Ra was 0.4 micrometers or less, the film was rated as “Excellent”; if Ra was greater than 0.4 micrometers, the film was rated as “Poor.”

### Suitability for Single Layer Use

If the release film could not have sufficient functions as a release film without a peel-off layer, the film was rated as “Poor”; if the release film had sufficient functions as a release film without the peel-off layer, the film was rated as “Excellent.”

| | Composition for POM | | | | | | |
|---|---|---|---|---|---|---|---|
| | | | Particulate | Median diameter | | | |
| | | MFR | thermal | (μm) of heat | Comonomer | | Preparation |
| | Composition | (g/10 min) | stabilizer | stabilizer | (mol%) | Main film | method |
| Example 1 | POM Composition 1 | 2.8 | H3 | 10 | 0 | Clear coating | Lamination |
| | | | | | | composition | |
| Example 2 | POM Composition 2 | 50 | H3 | 10 | 0 | Clear coating | Lamination |
| | | | | | | composition | |
| Comp. | POM Composition 3 | 100 | H3 | 10 | 0 | Clear coating | Lamination |
| Example 1 | | | | | | composition | |
| Example 3 | POM Composition 4 | 2.8 | H3 | 30 | 0 | Clear coating | Lamination |
| | | | | | | composition | |
| Comp. | POM Composition 5 | 2.8 | H3 | 100 | 0 | Clear coating | Lamination |
| Example 2 | | | | | | composition | |
| Example 4 | POM Composition 6 | 2.8 | NA900 | 40 | 0 | Clear coating | Lamination |
| | | | | | | composition | |
| Example 5 | POM Composition 7 | 2.8 | H3 | 10 | 2 | Clear coating | Lamination |
| | | | | | | composition | |
| Example 6 | POM Composition 1 | 2.8 | H3 | 10 | 0 | Black coating | Lamination |
| | | | | | | composition | |
| Example 7 | POM Composition 1 | 2.8 | H3 | 10 | 0 | Metallic coating | Lamination |
| | | | | | | composition | |
| Comp. | PET | — | — | — | — | — | Lamination |
| Example 3 | | | | | | | |
| Comp. | POM Composition 1 | 2.8 | H3 | 10 | 0 | 4600P (adhesive | Coextrusion |
| Example 4 | | | | | | layer) FG3DG | |
| | | | | | | (base layer) | |

| | Effects | | | | | |
|---|---|---|---|---|---|---|
| | | | | | Smoothness | Suitability |
| | Productivity | Appearance | Stiffness of | | of film | for single |
| | of film | of film | film | Peelability | surface | layer use |
| Example 1 | Excellent | Excellent | Excellent | Excellent | Excellent | Excellent |
| Example 2 | Fair | Excellent | Excellent | Excellent | Excellent | Excellent |
| Comp. | Poor | Excellent | Excellent | Excellent | Excellent | Excellent |
| Example 1 | | | | | | |
| Example 3 | Excellent | Fair | Excellent | Excellent | Excellent | Excellent |
| Comp. | Excellent | Poor | Excellent | Excellent | Excellent | Excellent |
| Example 2 | | | | | | |
| Example 4 | Excellent | Fair | Excellent | Excellent | Excellent | Excellent |
| Example 5 | Excellent | Excellent | Fair | Excellent | Excellent | Excellent |
| Example 6 | Excellent | Excellent | Excellent | Excellent | Excellent | Excellent |
| Example 7 | Excellent | Excellent | Excellent | Excellent | Excellent | Excellent |
| Comp. | Excellent | Excellent | Excellent | Poor | Excellent | Poor |
| Example 3 | | | | | | |
| Comp. | Excellent | Excellent | Excellent | Excellent | Poor | Excellent |
| Example 4 | | | | | | |

### INDUSTRIAL APPLICABILITY

The release film of the present disclosure has high rigidity, has excellent peelability, and can be suitably used as a release film to protect exterior films, particularly decorative films for automobiles.

1. A release film comprising a base layer containing a polyacetal resin.

2. The release film according to claim 1, composed only of the base layer.

3. The release film according to claim 1, wherein a melt flow rate of the polyacetal resin is 0.5 to 50 g/10 min.

4. The release film according to claim 1, wherein the base layer contains a heat stabilizer, and a median diameter (D50) of the heat stabilizer is 50 μm or less.

5. The release film according to claim 1, wherein the polyacetal resin is a copolymer, and the content of comonomers in the polyacetal resin is an amount equivalent to 2.0 mol % or less per 1 mol of trioxane.

6. The release film according to claim 1, being a release film for a decorative film for automobiles.

7. The release film according to claim 6, wherein the decorative film for automobiles is a decorative film for automobiles of a type where an adhesive is applied immediately before adhesion.

8. The release film according to claim 1, being a release film for a film containing metal pigment particles.

9. A laminate comprising a main film and the release film according to claim 1 laminated on at least one side of the main film.

10. The laminate according to claim 9, wherein, when an Ra of a surface of the release film after the main film is peeled off from the laminate, the surface of the release film being in contact with the main film before the peel-off of the main film, is 0.4 μm or less.

11. A method for manufacturing the laminate according to claim 9, comprising laminating a component for forming the main film onto one side of the release film.

12. A method for manufacturing a decorative film comprising:
(1) a step of obtaining a release film by extrusion molding a polyacetal resin;
(2) a step of coating a decorative layer or topcoat layer on a smooth surface of the release film obtained in (1) to obtain a laminate A;
(3) a step of coating an adhesive layer on the release film obtained in (1), and adhering the release film on the adhesive layer to obtain a laminate B; and
(4) a step of bonding the laminate A and the laminate B together after removing the release film from one side of the laminate B.

13. A single-layer release film (base layer) comprising a polyacetal resin.
